(19) United States
(12) Patent Application Publication
(10) Pub. No.: US 2017/0252910 A1
(43) Pub. Date: Sep. 7, 2017

(54) PIPE EXTRACTION TOOL

(71) Applicant: Nicholas J. Turner, Cotati, CA (US)

(72) Inventor: Nicholas J. Turner, Cotati, CA (US)

(21) Appl. No.: 15/330,955

(22) Filed: Jan. 20, 2016

Related U.S. Application Data
(60) Provisional application No. 62/109,208, filed on Jan. 29, 2015.

(51) Int. Cl. B25B 27/14; F16L 1/06; F16L 1/028

(52) U.S. Cl. CPC B25B 27/14; F16L 1/028; F16L 1/06

(57) ABSTRACT

A pipe extraction tool that grips the inside of a pipe or other hollow tube to facilitate removal of the object. The extraction tool employs a pick that is rotated from an axial position to engage and pierce the inner diameter of the pipe for removal.

### CROSS-REFERENCES TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention relates to a pipe extraction tool. More specifically, the present invention relates to a tool for extracting pipe or the like by gripping the inside of the pipe to facilitate removal thereof

2. Description of the Related Art

Pipes or other hollow tube-shaped devices are used in many situations as conduits for liquids and gases, as connectors for mechanical devices, and for special applications such as holders for removable pylons that separate traffic lanes. It is not uncommon for removal of a pipe to be difficult because the section to be removed is underground or firmly embedded inside another element, and therefore difficult to grasp on the exterior. Several tools have been developed to facilitate such removal, but most have complex expanding mechanisms that are expensive to manufacture due to their complexity. These expanding mechanisms also tend to be inadequate for removal when excessive force is required because their gripping strength is limited to sliding frictional force. For example, U.S. Pat. No. 7,448,303 teaches a pipe extraction tool where wrench jaws are expanded to engage the internal diameter of the pipe. Such a tool relies solely on frictional sliding force to remove the pipe, and therefore, is ineffective for pipes that are extremely difficult to remove. Other tools have been developed that can be screwed into the pipe for removal, however these tools are only useful if the walls of the pipe are sufficiently thick to allow engagement without obliterating them. The screw mechanisms also cause complete destruction of the pipe to be removed, preventing re-use of the object. The present invention resolves these issues by providing an elegant and inexpensive mechanism that pierces the interior of the pipe, creating maximum gripping power while only impacting a small portion of the interior of the object to be removed.

### BRIEF SUMMARY OF THE INVENTION

The present invention is a Pipe Extraction Tool comprised of a threaded shaft with a positioning nut that drives a cylindrical collar into a rotatable pick. The cylindrical collar is moved axially along the threaded shaft by rotating the positioning nut on the threaded shaft. Prior to insertion of the tool in the pipe to be extracted, the positioning nut is moved upward such that the cylindrical collar is raised away from the rotatable pick. In that position, the rotatable pick is aligned generally axially with the threaded shaft so that it can easily slide inside the pipe. After insertion of the tool into the pipe, the positioning nut is tightened such that it forces the cylindrical collar to engage the rotatable pick, moving it into a horizontal position and driving the sharp pick end into the inner wall of the pipe. The tool can then be pulled axially to extract the pipe. After extraction of the pipe, the positioning nut is loosened, backing the cylindrical collar away from the rotatable pick, and allowing the rotatable pick to return to the axial position, thus releasing the tool from the pipe.

### BRIEF DESCRIPTION OF THE SEVERAL VIEWS OF THE DRAWINGS

A more complete understanding of the present invention may be derived by referring to the detailed description when considered in connection with the figures, wherein like reference numbers refer to similar items throughout the figures, and:

FIG. 1 is a side view of one embodiment of the Pipe Extraction Tool showing the cylindrical collar raised so that it is not engaging the rotatable pick;

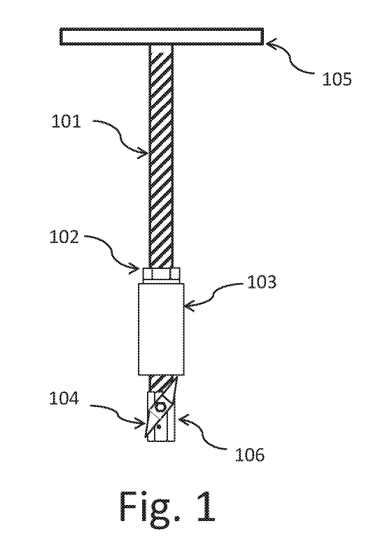

FIG. 2 is a side view of the Pipe Extraction Tool showing the cylindrical collar in the downward position such that the rotatable pick is forced into a horizontal position;

FIG. 3 shows several close-up views of the cylindrical collar and rotatable pick;

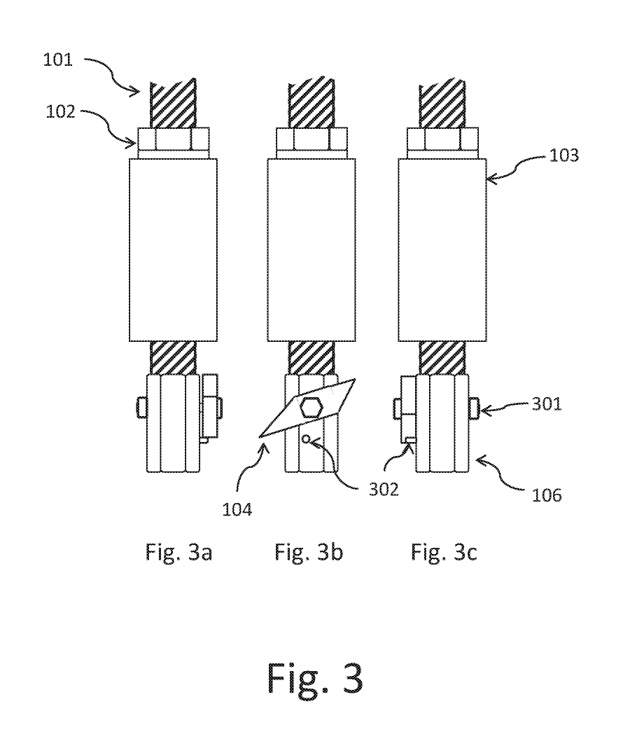

FIG. 4 shows the cylindrical collar in the downward position such that it is fully engaging the rotatable pick, and wherein the cross-section view is shown with the pipe in dotted outline and where the pipe is shown for illustrative purposes only and does not form a part of the invention; and

FIG. 5 shows two alternate configurations, one where the handle of the Pipe Extraction Tool forms a loop that can accommodate a large cross-bar for additional leverage, and the other with no handle attachment so that any attachment can be screwed on to the threaded end.

### DETAILED DESCRIPTION OF THE INVENTION

In the following detailed description of the invention, reference is made to the accompanying drawings which form a part of the disclosure and which show by way of illustration, and not of limitation, specific embodiments by which the invention may be practiced. The drawings, the foregoing discussion, and the following description are exemplary and explanatory only, and are not intended to limit the scope of the invention or its application in any manner.

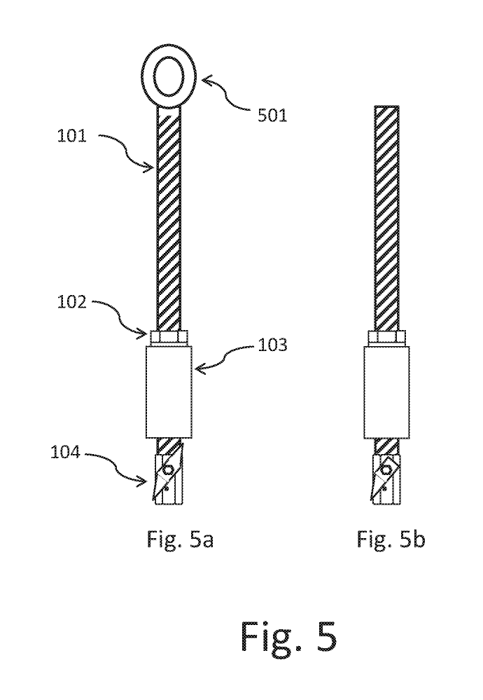

The present invention is comprised of a Threaded Shaft 101, a Positioning Nut 102, a Cylindrical Collar 103, an End. Nut 106 with a Dowel Assembly 301, and a Rotatable Pick 104. The Threaded Shaft 101 is preferably made of steel and has a Handle 105 at the top suitable for manual gripping. In an alternate configuration as shown in FIG. 5a, the Threaded Shaft 101 may be configured with a Loop 501 at the top that is suitable for inserting a long shaft for improved leverage to extract the pipe. In yet another alternate configuration, as shown in FIG. 5b, there is no handle attachment so that any attachment can be screwed on to the top threaded end of the Threaded Shaft 101. An End Nut 106 is permanently attached or firmly secured onto the bottom of the Threaded Shaft 101.

A Dowel Assembly 301 is inserted horizontally through the End Nut 106 such that it secures the Rotatable Pick 104 to the End Nut 106, while allowing the Rotatable Pick 104 to rotate around the Dowel Assembly 301 axis. The Dowel Assembly 301 may be either a simple metal dowel with a nut or welded component on each end, or it may be made from a screw, nut and washer combination, or other suitable configuration, as long as the Rotatable Pick 104 is free to rotate around the Dowel Assembly 301 axis, and the overall length of the Dowel Assembly 301 does not exceed the inner diameter of the Pipe 401 that is to be extracted. The End Nut 106 preferably has a flat surface on the side where the Rotatable Pick 104 is located so the Rotatable Pick 104 may rotate without obstruction or friction around the Dowel Assembly 301 axis.

The Rotatable Pick 104 is made of steel or other suitable material that is stronger than the material of the Pipe 401 that is to be extracted such that when the Rotatable Pick 104 is forced into the side of the Pipe 401, it pierces the material of the Pipe 401 and the Rotatable Pick 104 is not deformed. The Rotatable Pick 104 preferably has a sharp point on both ends, but in an alternate configuration, may have a single sharp point as shown in FIG. 5b.

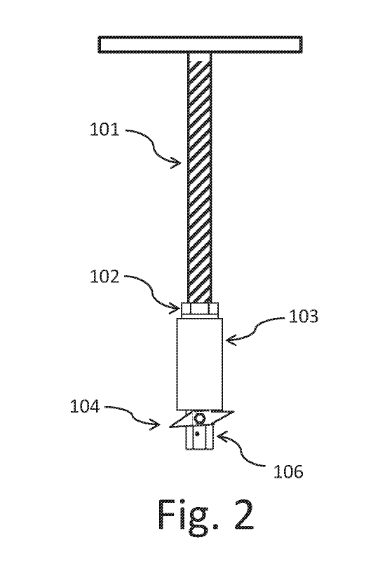

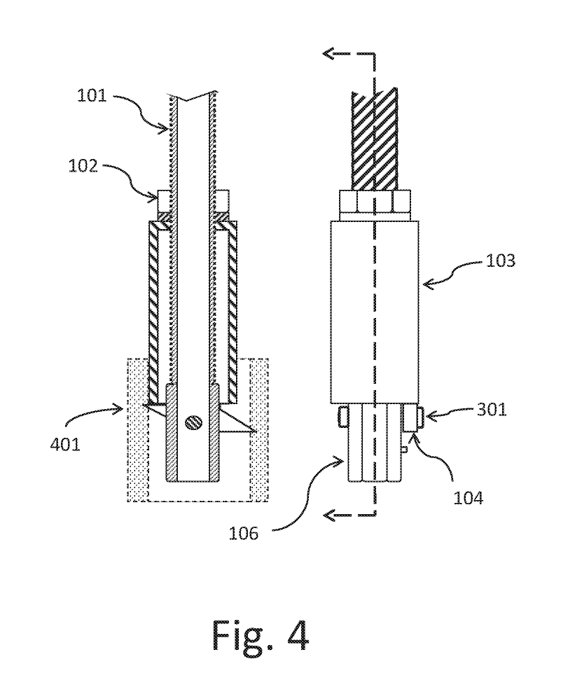

In a preferred embodiment, there is a Pick Stop 302 inserted in or attached to the End Nut 106 that prevents the Rotatable Pick 104 from moving past a vertical angle when the Cylindrical Collar 103 is in the raised position. The Pick Stop 302 ensures that when the Cylindrical Collar 103 is moved against the Rotatable Pick 104, the Cylindrical Collar 103 engages the side of the Rotatable Pick 104 so that it is forced into a horizontal position as shown in FIGS. 2 and 4.

The Cylindrical Collar 103 is preferably made of steel and has an inner diameter that is large enough to fit over the End Nut 106, but is small enough to engage the Rotatable Pick 104. After the tool is inserted into the Pipe 401 that is to be extracted, the Positioning Nut 102 is tightened downward, forcing the Cylindrical Collar 103 against the Rotatable Pick 104 and moving it into a horizontal position. The Rotatable Pick 104 and the outer diameter of the Cylindrical Collar 103 are configured such that when the Rotatable Pick 104 is in approximately the horizontal position, the Cylindrical Collar 103 is forced against one side of the Pipe 401, and the Rotatable Pick 104 digs into the other side of the Pipe 401, providing maximum gripping power as shown in FIG. 4. With the Rotatable Pick 104 digging into the inner diameter of the Pipe 401, the tool is used to extract the Pipe 401.

After extraction of the Pipe 401, the Positioning Nit 102 is loosened to allow the Rotatable Pick 104 to return to an axial orientation and releasing it from the inner diameter of the Pipe 401.

Many modifications and variations of this invention may be made without departing from its spirit and scope, as will be appreciated by those skilled in the art. For example, rather than using a Pick Stop 302 to ensure the Cylindrical Collar 103 properly engages the Rotatable Pick 104, a Rotatable Pick 104 with only a single sharp point could have a symmetrical shape with a rounded back end that would serve the same purpose. The embodiment as described herein was chosen and described in order to best explain the principles of the invention and its practiced applications.

What is claimed is:

1. A pipe extraction tool for extracting a pipe with an inner diameter, said pipe extraction tool having a bottom end that is inserted in the pipe and comprising:
(a) a threaded shaft with a longitudinal axis, a top end, and a bottom end;
(b) a rotatable positioning nut that is screwed onto the threaded shaft near the top end of the threaded shaft;
(c) an end nut that is securely attached to the bottom end of the threaded shaft;
(d) a dowel inserted through the center of the end nut at a 90 degree angle to the longitudinal axis of the threaded shaft;
(e) a cylindrical collar with a top end, a bottom end, an external diameter that is smaller than the inner diameter of the pipe, an internal diameter at the bottom end that is larger than the end nut, and an inner diameter at the top end that is larger than the threaded shaft but is smaller than the positioning nut, that is positioned between the positioning nut and the end nut on the threaded shaft such that when the positioning nut is rotated, it moves the cylindrical collar up and down the threaded shaft; and
(f) a pick that is rotatably attached to the dowel with a long axis, at least one sharp end, a flat top side, and overall dimensions such that when the pick is rotated so that its long axis is somewhat aligned with the longitudinal axis of the threaded shaft, the bottom end of the pipe extraction tool can be inserted into the pipe and, after the pipe extraction tool is inserted into the pipe and the positioning nut is rotated to move the cylindrical collar toward the bottom end of the threaded shaft, the bottom end of the cylindrical collar is forced against the fiat top side of the pick, rotating the pick to a position where its long axis is perpendicular to the longitudinal axis of the threaded shaft, and at least one sharp end of the pick pierces the inner diameter of the pipe such that the pipe extraction tool grips the pipe so it can be extracted.

2. The pipe extraction tool of claim 1, further comprising a means for stopping the pick from rotating to a position where its long axis is aligned with the longitudinal axis of the threaded shaft.

3. The pipe extraction tool of claim 1, further comprising a handle attached to the top of the threaded shaft.

4. The pipe extraction tool of claim 1, further comprising a loop at the top of the threaded shaft suitable for inserting a bar to increase leverage for extracting the pipe.

5. The pipe extraction tool of claim 2, further comprising a handle attached to the top of the threaded shaft.

6. The pipe extraction tool of claim 2, further comprising a loop at the top of the threaded shaft suitable for inserting a bar to increase leverage for extracting the pipe.
